(19) United States
(12) Patent Application Publication
(10) Pub. No.: US 2012/0052844 A1
(43) Pub. Date: Mar. 1, 2012

(54) MOBILE TERMINAL AND METHOD FOR DELETING MESSAGE

(75) Inventor: ZU-HONG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/158,683

(22) Filed: Jun. 13, 2011

(30) Foreign Application Priority Data
Aug. 31, 2010 (CN) 201010268146.6

(51) Int. Cl. H04M 1/725; H04M 1/64

(52) U.S. Cl. 455/412.1

(57) ABSTRACT

A mobile terminal includes a storing module, an analysis module, and a processing module. The storing module is used for storing a plurality of messages. The analysis module is used for obtaining a message number corresponding to a selected message of the plurality of messages after determining a storing time of the selected message stored in the storing module more than a reference time when the selected message is in a read and unlocked status. The processing module is used for deleting the selected message according to the message number.

### CROSS-REFERENCE TO RELATED APPLICATIONS

Relevant subject matter is disclosed in co-pending U.S. Patent Applications entitled “MOBILE TERMINAL AND METHOD FOR LOCKING MESSAGE”, Attorney Docket Number US35196, U.S. application Ser. No. ______, Filed on ______.

### BACKGROUND

1. Technical Field

The present disclosure relates to mobile terminals and methods, and particularly to, an mobile terminal and method for deleting messages.

2. Description of Related Art

Message service is widely applied in all kinds of mobile terminals. Each mobile terminal can store hundreds of messages. Sometimes, the user must delete messages to save memory of the mobile terminal However, it may take too much time to delete these messages.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a mobile terminal in accordance with an embodiment.

FIG. 2 is a flow chart of a method for deleting a message in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

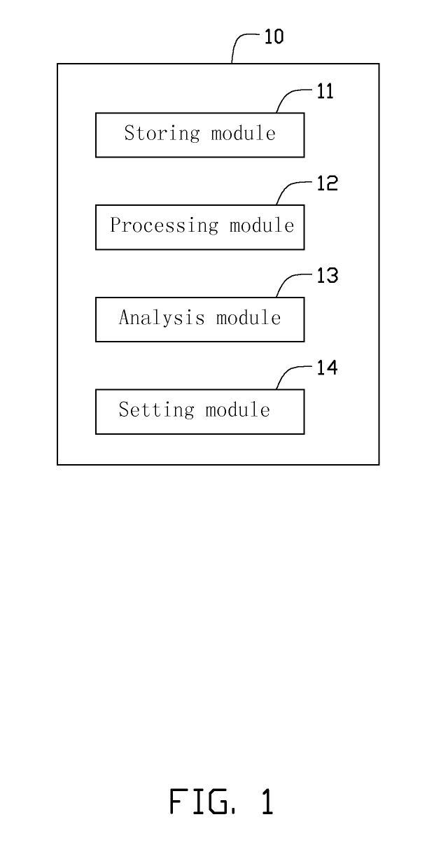

Referring to FIG. 1, a mobile terminal 10 includes a storing module 11, a processing module 12, an analysis module 13, and a setting module 14.

The storing module 11 is used for receiving and storing messages from message senders. The message senders may be, for example, contacts that have been in communication with the user. Each message includes 2 bytes for storing a message number, 10 bytes for storing the name or telephone number of the message sender, 12 bytes for storing the receiving time, 1 byte for storing a read label, 160 bytes for storing the content of the message, and N bytes for storing other data. If the name of the message sender is stored in the mobile terminal 10, the 10 bytes stores the name of the message sender; and if the name of the message sender is not stored in the mobile terminal 10, the 10 bytes stores the telephone number of the message sender. A message number corresponds to a message. For example, in the storing module 11, a message number of the first message is 1, a message number of the second message is 2. Likewise, a message number of the Nth message is N.

The analysis module 13 is used for analyzing a storing time of a selected message in the storing module 11. The selected message is read and unlocked by a user. The storing time shows how long the selected message is stored in the storing module 11. If the storing time is more than a reference time, the analysis module 13 obtains a message number corresponding to the selected message and sends the message number to the processing module 12.

The processing module 12 is used for deleting the selected message according to the message number.

The setting module 14 is used for setting different reference times corresponding to different names or telephone numbers of message senders. The setting module 14 is also used for setting different reference times corresponding to different groups, such as a family group, a friend group, stored in the mobile terminal 10.

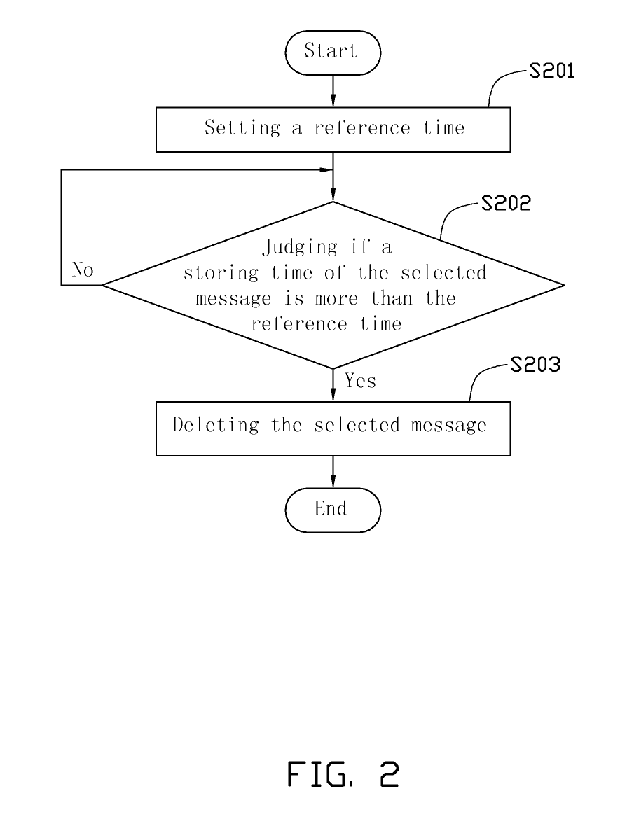

Referring to FIGS. 1 and 2, a method for deleting a message is shown. An embodiment of the method is as follows.

In step S201, the setting module 14 sets a reference time.

In step S202, the analysis module 13 judges if a storing time of the selected message is more than the reference time. If so, the analysis module 13 sends the message number corresponding to the selected message to the processing module 12, and turns to the step S203. If not, the flow goes on the step S202. In the step S202, the analysis module 13 further obtains the name or telephone number of the message sender and the receiving time corresponding to the message.

In step S203, the processing module 12 deletes the selected message according to the message number.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A mobile terminal, comprising:
a storing module, the storing module adapted to store a plurality of messages;
an analysis module, the analysis module adapted to obtain a message number corresponding to a selected message of the plurality of messages after determining a storing time of the selected message stored in the storing module more than a reference time when the selected message is in a read and unlocked status; and
a processing module, the processing module adapted to delete the selected message according to the message number.

2. The mobile terminal of claim 1, wherein the analysis module is further adapted to obtain a name or a telephone number of a message sender, and a receiving time corresponding to the selected message, and send the name or the telephone number of the message sender and the receiving time to the storing module when the analysis module obtains the message number.

3. The mobile terminal of claim 1, further comprising a setting module, wherein each of the plurality of messages comprises a name or a telephone number of a message sender, and the setting module is adapted to set the reference time according to a name or telephone number of the selected message.

4. The mobile terminal of claim 1, further comprising a setting module, wherein the storing module stores a plurality of groups, and the setting module is adapted to set the reference time according to a group of the plurality of groups.

5. A method for deleting a message, applied in a mobile terminal, the method comprising:
setting a reference time;
obtaining a message number corresponding to a selected message stored in the mobile terminal after determining a storing time of the selected message stored in the mobile terminal more than the reference time, the selected message is read and unlocked by a user; and
deleting the selected message according to the message number.

6. The method of claim 5, further comprising obtaining a name or a telephone number of a message sender and a receiving time corresponding to the read and unlocked message; and
storing the name or the telephone number of the message sender and the receiving time when obtaining the message number.

7. The method of claim 5, wherein different reference times are set according to different names or telephone numbers of message senders.

8. The method of claim 5, wherein different reference times are set according to different group stored in the mobile terminal

9. A method for deleting a message, comprising:
providing a mobile terminal, the mobile terminal comprising a storing module storing a plurality of messages, an analysis module, a processing module, and a setting module;
the setting module setting a reference time;
the analysis module obtaining a message number corresponding to a selected message of the plurality of messages that is read and unlocked by a user after determining a storing time of the selected message more than the reference time; and
the processing module deleting the selected message according to the message number.

10. The method of claim 9, further comprising obtaining a name or a telephone number of a message sender and a receiving time corresponding to the selected message and storing the name or the telephone number of the message sender and the receiving time when obtaining the message number.

11. The method of claim 9, wherein different reference times are set according to different message sender names or telephone numbers.

12. The method of claim 9, wherein different reference times are set according to different group stored in the mobile terminal
